(19) United States
(12) Patent Application Publication
(10) Pub. No.: US 2002/0173275 A1
(43) Pub. Date: Nov. 21, 2002

(54) Radio telecommunication network

(76) Inventor: Francois Coutant, Mulsanne (FR)

Correspondence Address: PHILIPS ELECTRONICS NORTH AMERICAN CORP, 580 WHITE PLAINS RD, TARRYTOWN, NY, 10591, US

(21) Appl. No.: 10/145,638

(22) Filed: May 15, 2002

(30) Foreign Application Priority Data
May 15, 2001 (FR) 0106393

(51) Int. Cl. H04B 17/00

(52) U.S. Cl. 455/67.1; 455/67.3

(57) ABSTRACT

The invention relates to the field of telecommunication networks of the GSM type. A telecommunication network comprises at least one terminal, for example 105, able to switch from idle mode to dedicated mode when a communication is established and a plurality of cells, for example 101 and 102, on which the terminal can camp in idle mode or dedicated mode and controlled by base stations, for example 103, intended to manage such a switching when a communication is established. One purpose of the invention is to avoid a terminal camping in idle mode on a cell on which it cannot camp in dedicated mode, because of a fault in the base station controlling this cell, at the time of switching. For this purpose, the terminal comprises detection means 109 able to detect a fault in a base station at the time of switching, means 110 of identifying the cell controlled by such a faulty base station, means 111 of establishing a black list of cells controlled by faulty base stations and means 112 of selecting a cell for camping of the terminal in idle mode, a selection criterion being the presence or not of a cell in the black list.

The invention has an interest for all mobile networks, an interest which is all the greater, the older the installations in the network, since the number of faulty base stations may then be relatively high.

### FIELD OF THE INVENTION

The invention relates to a telecommunication network comprising

at least one terminal which can switch from an idle mode to a dedicated mode when a communication is established, and

a plurality of cells on which said terminal can camp in idle mode or dedicated mode, controlled by base stations intended to manage such a switching when a communication is established.

The invention also relates to a terminal intended to be used in such a telecommunication network.

The invention furthermore relates to a data processing method for such a terminal.

Finally, the invention relates to a program comprising program code instructions for executing steps of this method when said program is executed on a processor.

The invention finds its application, for example, in a telecommunication network of the GSM type (GSM is the abbreviation of “Global System for Mobile communications”).

### BACKGROUND OF THE INVENTION

A telecommunication network generally comprises terminals and base stations which provide entry points for the terminals to the network. Such a network is divided into hexagonal cells, each cell being controlled by a base station, the dimensions of the sides of such a cell being able to vary from a few tens of meters in an urban environment to a few kilometers in a rural environment. A terminal may be in idle mode, when it is switched on and is not in communication. A base station continuously sends signals intended to be received by the terminals situated in the cell which it controls and in adjacent cells. When it is in idle mode, a terminal makes power measurements of the signal sent by the base stations which are closest to it, and camps on the cell controlled by the base station which sends the signals generating the highest power level, that is to say it is this base station which will enable it to establish communication with another terminal. When a terminal has established communication with another terminal, it is said that it is in dedicated mode. The document published by the ETSI in February 1995, entitled “European Digital Cellular Telecommunications System (Phase 2); Mobile Radio Interface Layer 3 Specification (GSM 04.08)” describes data frames exchanged between a terminal and a base station in idle mode and in dedicated mode, as well as various protocols for effecting switching from idle mode to dedicated mode in order to establish communication. The protocols described enable a terminal to switch to a dedicated mode only by means of the base station controlling the cell on which it is camping in idle mode. However, a base station may be faulty, so that it is possible for a terminal to camp on the cell which it controls in idle mode but for it to be impossible to switch to a dedicated mode on this cell. In this situation, a user having a terminal camping in idle mode on such a cell thinks that he is able to establish a communication with another terminal, and therefore in particular to be able to be reached, whereas this is not the case. This is an appreciable drawback for users which is all the more marked in a old telecommunication network in which a good number of base stations may be faulty.

### SUMMARY OF THE INVENTION

It is an object of the invention to propose a telecommunication network enabling a terminal not to camp in idle mode on a cell on which it cannot switch to a dedicated mode.

A telecommunication network according to the invention and as defined in the opening paragraph is characterized in that said terminal comprises:

detection means able to detect a fault in a base station at the time of said switching;

means of identifying the cell controlled by such a faulty base station;

means of establishing a black list of cells controlled by faulty base stations;

means of selecting a cell for camping of said terminal in idle mode, a selection criterion being the presence or not of this cell in the black list.

A terminal according to the invention and as defined in the opening paragraph appears in claim 2.

A data processing method according to the invention and as defined in the opening paragraph appears in claim 7.

In accordance with the invention, a black list of faulty base stations is established as follows. When a first terminal camps in idle mode on a cell and wishes to establish a communication with a second terminal, it is possible that it does not manage to switch to a dedicated mode. In the same way, when the second terminal attempts to establish a communication with the first, it is possible that the latter does not manage to do so. This may have several causes, for example a fault in the base station which controls this cell. In such a case, the detection means detect that the base station in question is faulty. The identification means store information relating to an identity of the cell controlled by this faulty base station, this information being different for all the cells in the world, so that, knowing this information, it is impossible to confuse two cells. The establishment means can then group together the information stored by the identification means in order to create a black list containing the identities of all the cells controlled by faulty base stations. When a terminal wishes to camp in idle mode on a given cell, for example since the power of the signals received from the base station controlling this cell is high, the identity of this cell makes it possible to know whether or not this cell is in the black list. If this cell is in the black list, the selection means can then decide not to camp on this cell. Thus a terminal avoids camping in idle mode on a cell on which it is not possible for it to be in dedicated mode.

In a particularly advantageous embodiment of the invention, a terminal as described above is characterized in that a cell exits from said black list after a certain predetermined period following its entry. According to this embodiment, a terminal can attempt to switch to a dedicated mode on a cell which has left the black list. However, whilst this cell was in the black list, it is possible than an operator has repaired the base station controlling it. If such is the case, the terminal will once again be able to switch to a dedicated mode on this cell.

In a variant of the invention, a terminal as described above is characterized in that said establishment means comprise at least one counting system per cell able to count a number of faults in the base station controlling this cell, said cell entering said black list after a predetermined non-zero number n of faults.

This embodiment makes it possible to put a cell in the black list only after a certain number of faults in the base station controlling this cell, so as to ensure that this base station is indeed faulty.

In an advantageous embodiment of this variant, a terminal as described above is characterized in that:

a counting system associated with a cell present in the black list counts a fault each time the terminal wishes to camp on this cell in idle mode, and

a cell leaves said black list when the counting system associated with said cell indicates a predetermined number m of faults strictly greater than n.

According to this embodiment, it is possible to make a cell leave the black list at the end of a period which is possibly less than that set in the particularly advantageous embodiment of the invention. The advantageous embodiment of this variant has notably an advantage in a geographical area where the cell density is relatively low, for example in a rural environment. If it is assumed that a user of a terminal lives in a rural environment and each morning leaves his home in order to go and work several kilometers away. When he switches on his terminal in the morning, the terminal then measures a high power of the signals transmitted by the closest base station, and a low power of the signals transmitted by the adjoining base stations which are situated at relatively great distances. The terminal then wishes to camp on the closest cell. If this cell is in the black list, the counting system associated with this cell counts a fault. An identical scheme occurs when the user returns from his work in the evening. Consequently, the counting system counts around ten faults in a week. However, the closest cell being in the black list, the terminal camps in dedicated mode on relatively distant cells, which causes relatively poor communication qualities. It is therefore advantageous for the cell to leave the black list relatively frequently, so that the terminal can test whether the base station controlling this cell has been repaired. In the above example, if the value m is fixed at 20, the cell in question will leave the black list approximately two weeks after its entry.

In another embodiment of this variant, a terminal as described above is characterized in that it comprises means of reinitializing a counting system, such a reinitialization taking place either at the time of a successful switching by the base station controlling the cell associated with said counting system, or when this cell exits from the black list. According to this embodiment, a cell does not enter the black list when the base station controlling it is not faulty. This is because it is possible for a switching from an idle mode to a dedicated mode to fail for reasons external to the base station, for example if the terminal is passing under a tunnel at the time of this switching. If it is assumed that n is for example equal to two, the terminal has the possibility of attempting for a second time to switch to a dedicated mode on this cell. If the base station is not faulty, it is highly probable that this switching will not fail a second time, in which case the counting system associated with this cell is reinitialized. Thus, if a switching fails once again for reasons external to the base station, the cell controlled by this base station will not enter the black list.

Since the steps described above can be effected by software, the invention also provides a program comprising program code instructions for executing steps of the method described above when said program is executed on a processor.

### BRIEF DESCRIPTION OF THE FIGURES

The invention will be further described with reference to examples of embodiments shown in the drawings, to which, however, the invention is not restricted.

FIGS. 1a and 1b illustrate characteristics of the invention;

FIGS. 2a and 2b illustrate structures of data frames exchanged between a terminal and a base station;

FIG. 3 is a flow diagram which illustrates detection of a fault in a base station when switching from idle mode to dedicated mode;

FIG. 4 is a flow diagram which illustrates the entry of a cell into a black list;

FIGS. 5a and 5b are two flow diagrams which illustrate two ways of leaving a black list;

FIG. 6 is a flow diagram which illustrates an example of the selection of a cell for camping in idle mode and a management of a black list.

### DETAILED DESCRIPTION OF AT LEAST ONE EMBODIMENT OF THE INVENTION

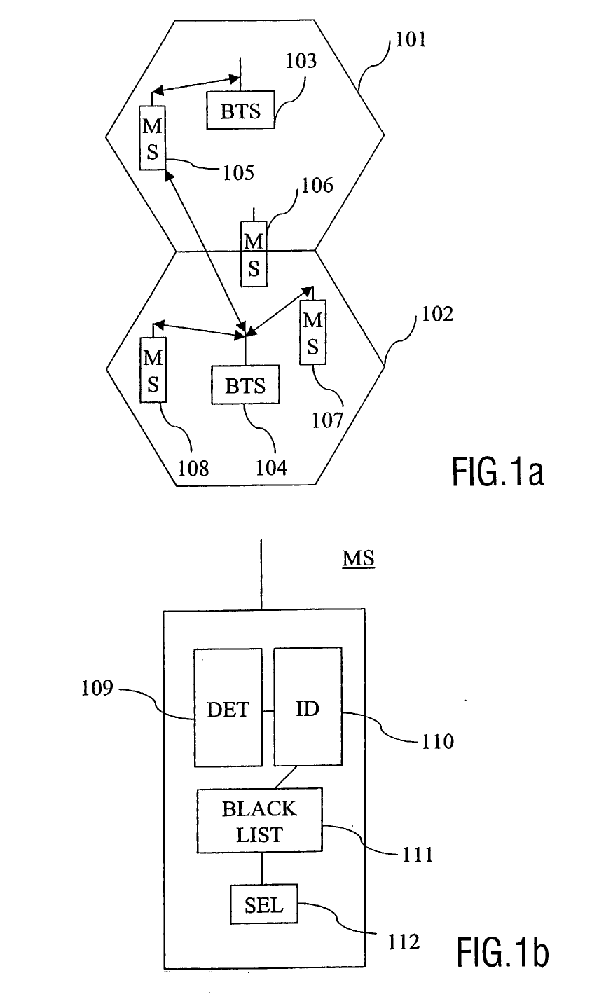

FIG. 1a illustrates a telecommunication network according to the invention. Such a telecommunication network comprises at least a first cell 101, a second cell 102, a first base station 103, a second base station 104, a first terminal 105, a second terminal 106, a third terminal 107 and a fourth terminal 108. Other elements, not shown in the figure but known to persons skilled in the art, for example in the case of a GSM network, are also necessary in such a network.

In the example depicted in FIG. 1a, the first terminal 105, when it is in idle mode, exchanges signals with the first base station 103 and with the second base station 104. It measures powers of signals received from these two base stations in order to determine on which cell it is camping in idle mode. Such measurements are necessary notably when the first terminal 105 moves from the first cell 101 to the second cell 102. In the case of the GSM network, the first terminal 105 generally measures, at regular intervals, the powers of the signals received from the thirty-two closest base stations. Amongst these thirty-two base stations, those corresponding to the six highest powers constitute a list of close neighbors, the others constitute a list of distant neighbors. The first terminal 105 stores information relating to the cells present in these two lists in a non-volatile memory. The set of these two lists constitutes a list of neighbors. The description given above applies to all the terminals present in the telecommunication network, notably to the second terminal 106, to the third terminal 107 and to the fourth terminal 108. Such terminals according to the invention also have functionalities described in FIG. 1b.

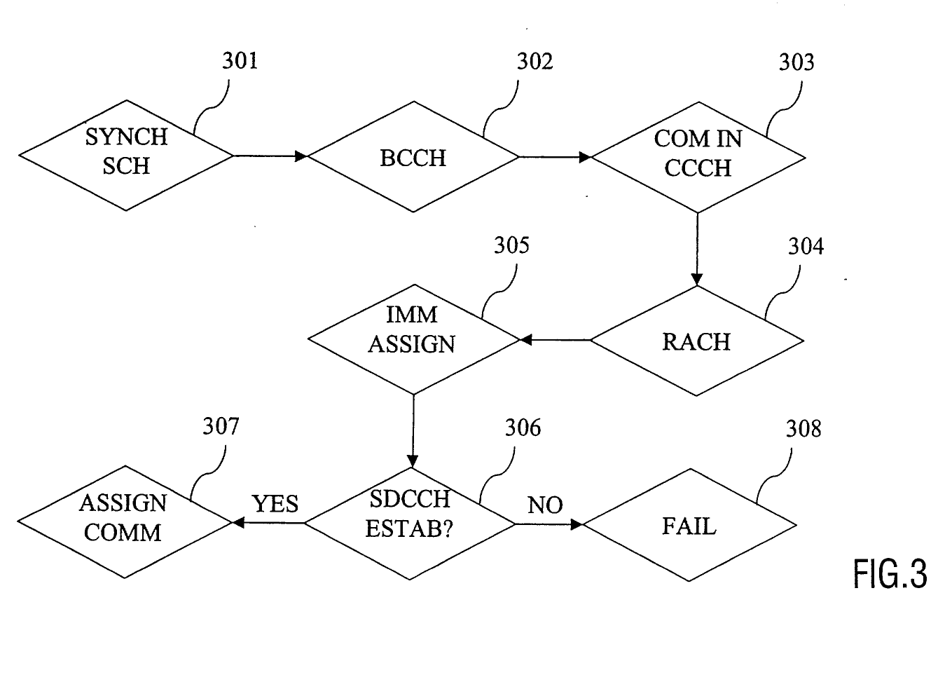

FIG. 1b illustrates a terminal according to the invention. Such a terminal comprises detection means 109, identification means 110, means of establishing a black list 111 and selection means 112. The detection means 109 make it possible to detect a fault in a base station when switching from idle mode to dedicated mode. Their functioning will be detailed in FIG. 3. When such a fault is detected by the detection means 109, the identification means 110 store, in a non-volatile memory, information relating to the cell controlled by this faulty base station. This information is:

a location area code LAC;

a mobile network code MNC;

a country code MCC;

a cell identity CI.

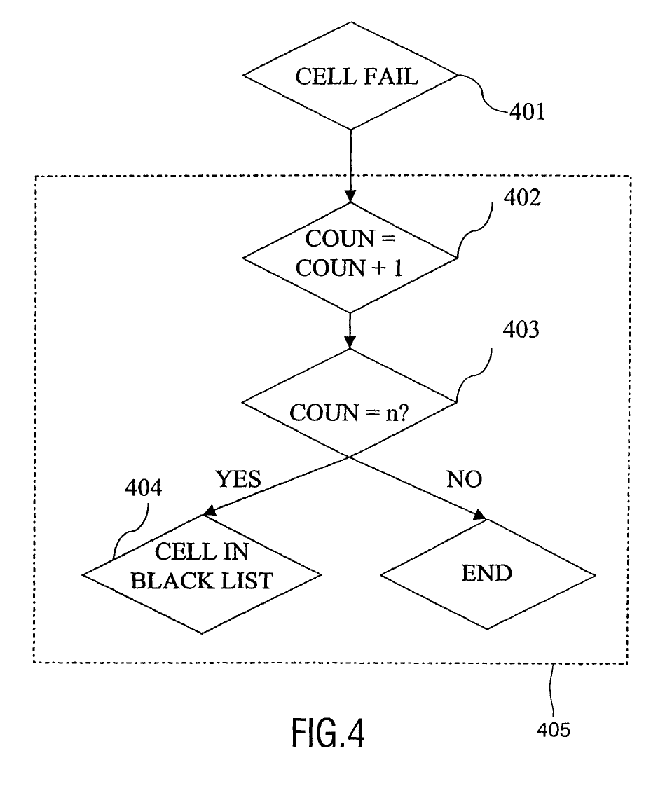

The black list establishment means 111 establish, notably by means of this information, a black list of cells controlled by faulty base stations. Functioning will be specified in FIGS. 4 to 6.

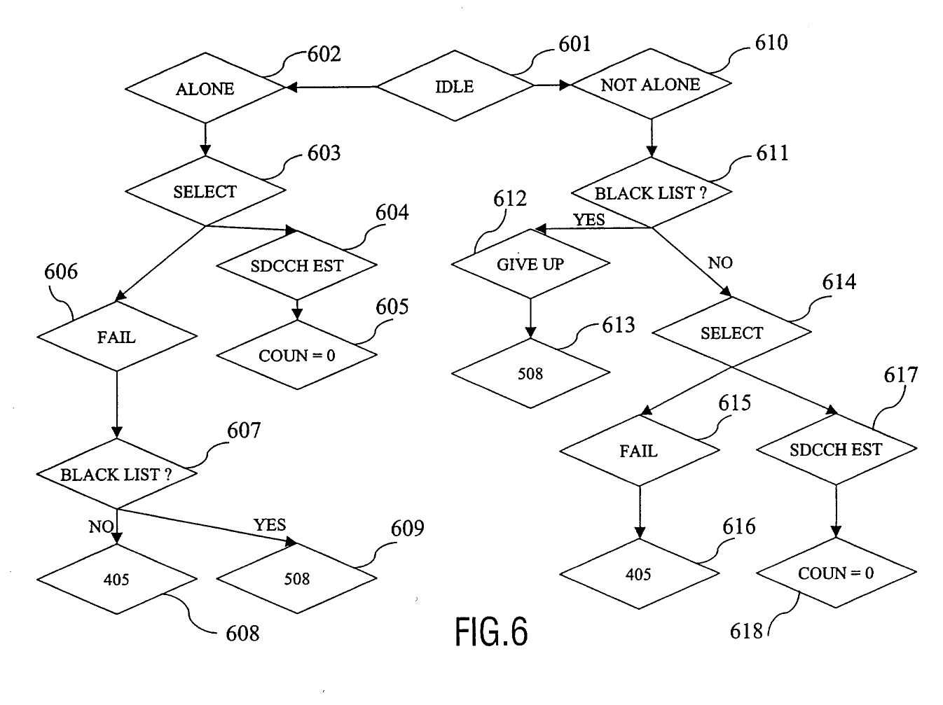

The functioning of the selection means 112 will be specified in FIG. 6.

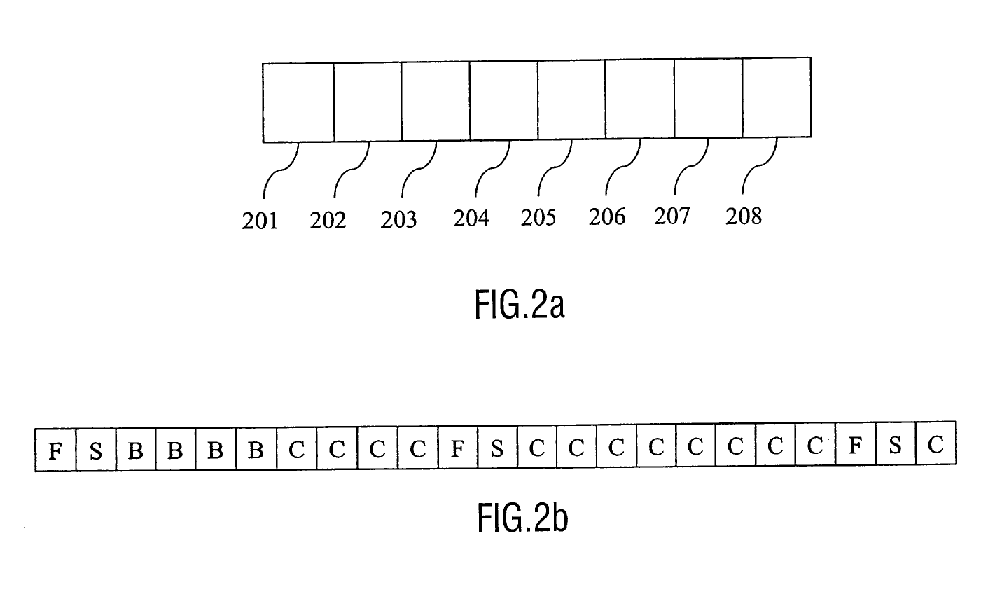

FIG. 2a depicts a time multiple access frame TDMA. Such a frame comprises a beacon channel 201, a signaling slot 202 and six traffic slots numbered 203 to 208. Such a frame TDMA is an essential element in a communication network of the GSM type 900 for which the frequency of signals sent from a terminal to a base station is between 890 and 915 megahertz and the frequency of the signals sent from a base station to a terminal is between 935 and 960 megahertz. In such a network, frequency bands of 25 megahertz are divided into 124 carrier frequencies spaced apart by 200 kilohertz. Each of these frequencies is then divided into time slots with a duration of 0.576 microseconds, a set of eight consecutive time slots forming a time multiple access frame TDMA. Logic channels result from periodic repetitions of time slots. The beacon channel 201 is the time slot used for a communication between a terminal and a base station when the terminal is in idle mode. The signaling slot 202 is used notably to allow switching from idle mode to dedicated mode. One of the six traffic slots numbered 203 to 208 is used when the terminal is in dedicated mode, notably for carrying the voice of a user of such a terminal. The frame TDMA depicted in FIG. 2a corresponds to two carrier frequencies, for example the frequency 890.2 megahertz from the terminal to the base station and the frequency 935.2 megahertz from the base station to the terminal. Thus six different terminals can use the same frequencies for camping simultaneously on the same cell in dedicated mode, each using one of the six traffic slots numbered 203 to 208.

FIG. 2b depicts a succession of logic channels on the beacon channel 201, from a base station to a terminal. Each element of this succession, represented by a square, is a time slot. The time slots depicted here are in fact separated by a period of 4.615 milliseconds, that is to say the duration of a TDMA frame; a repetition of time slots of the same type forms a logic channel. The various logic channels shown here are as follows:

F: frequency correction channel FCCH for tuning a terminal to a carrier frequency;

S: synchronization channel SCH for synchronizing a terminal with a base station;

B: broadcast control channel BCCH for broadcasting information from a base station;

C: common control channel CCCH.

The broadcast control channel BCCH is used by a base station for transmitting, to a set of terminals, information relating to the cell controlled by this base station, such as the location area code LAC, the mobile network code MNC, the country code MCC and the cell identity CI. The common control channel CCCH is notably used by a base station for informing a terminal that another terminal is seeking to establish a communication with it and for transmitting to it information relating to a channel which it must use for establishing this communication.

The beacon channel 201 from a terminal to a base station comprises essentially a random access channel RACH by means of which the terminal accesses the network in a random fashion in order to establish a communication.

FIG. 3 illustrates detection of a fault in a base station when switching from idle mode to dedicated mode. At box 301, a terminal synchronizes with the base station on which it is camping in idle mode. For this purpose it uses information contained in the channel FCCH and in the channel SCH. At box 302, the terminal stores information relating to an identity of the cell controlling this base station. At box 303, information contained in the channel CCCH indicates to the terminal that another terminal is attempting to reach to it. At box 304, the terminal then requests that a stand-alone dedicated control channel SDCCH be allocated to it in order to establish this communication. Such an establishment of communication requires a protocol exchange, which takes place on a channel SDCCH of the signaling slot 202. The signaling slot 202 generally comprises eight channels SDCCH. At box 305, the base station indicates to the terminal which of the eight channels SDCCH it must use to effect the protocol exchange. However, at a base station, various electronic cards manage the various time slots of the TDMA frames. Thus it is probable that the electronic card managing the beacon channel 201 will be functioning, whilst the electronic card managing the signaling slot 202 will be faulty. In such a situation, the terminal can camp in idle mode on the cell controlled by the base station, but will not be able to switch to dedicated mode on this cell. At box 306, the terminal attempts to exchange the protocol on the channel SDCCH allocated to it. If it manages to do so, that is to say if the electronic card managing the signaling slot 202 is functioning, the base station sends to it a control signal at box 307 in order to indicate to it a traffic channel TCH on which the terminal must establish communication, each traffic slot comprising a traffic channel TCH. If it does not manage to do so, that is to say if the electronic card managing the signaling slot 202 is not functioning, a fault in the base station is detected at box 308.

It may happen that the network is “saturated”, that is to say all the traffic channels of a base station are simultaneously being used. In this case, it is not possible to establish communication, that is to say to switch to dedicated mode on the cell controlled by this base station, although this base station is functioning perfectly. However, in such a situation, the terminal will not detect any fault in the base station. This is because the channels SDCCH of the base station are rarely all used simultaneously, which means that, even in the case of a saturated network, the box 307 will be reached.

FIG. 4 illustrates the entry of a cell into the black list. At box 401, a fault in a base station controlling a cell is detected by the detection means 109. A counting system associated with this cell counts a fault at box 402. At box 403, a terminal checks whether this counting system is then indicating a number of faults equal or not to a number n which can be set by the manufacturer of such a terminal. For example, n can have the value 2. If the counting system indicates a number of faults equal to the number n, the cell enters the black list, at box 404, that is to say the information relating to the identity of this cell is stored in the black list. If the counting system indicates a number of faults less than n, nothing happens after box 403. Boxes 402 to 404 form an algorithm for entry into a black list 405.

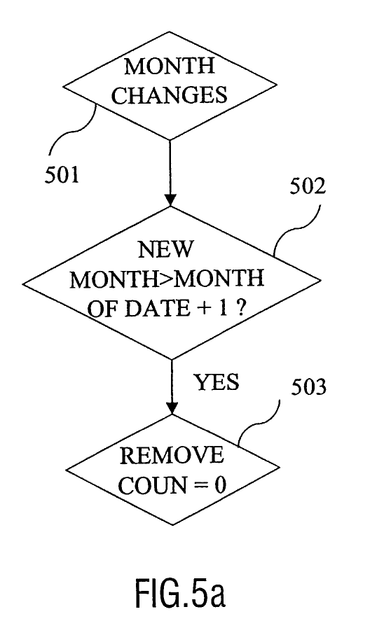

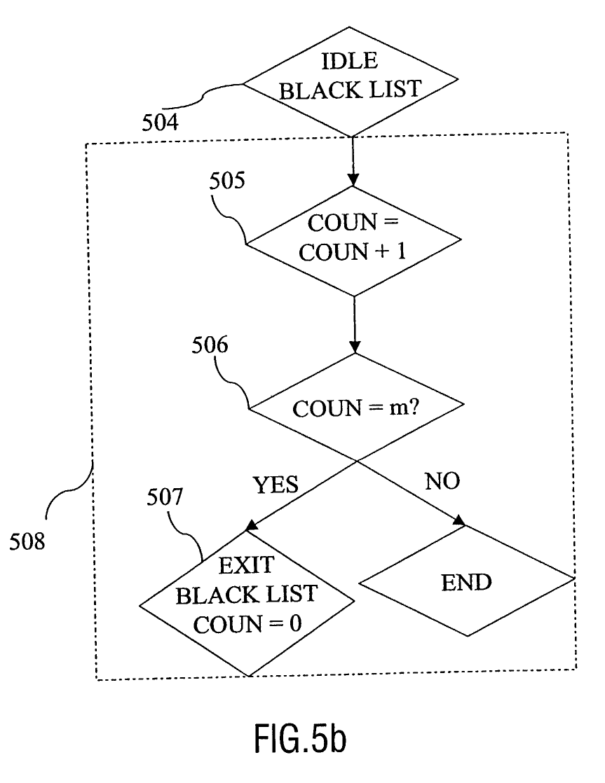

FIG. 5a illustrates a method of exiting from a black list. When a cell enters the black list, the terminal stores an entry date of this cell into the black list. When a change of month occurs at box 501, the terminal checks, at box 502, for each cell present in the black list, whether a number corresponding to the new month is strictly greater than the month corresponding to the month of entry of the cell into the black list, increased by one unit. If such is the case, the cell exits from the black list at box 503 and the counting system associated with this cell is reinitialized by reinitialization means. Otherwise the cell remains in the black list. This enables a cell to exit from the black list at the earliest one month after its entry, and at the latest two months after its entry.

FIG. 5b illustrates another method of exiting from the black list. In box 504, the terminal wishes to camp in idle mode on a cell present in the black list. The counting system associated with this cell counts a fault at box 505. In box 506, the terminal checks whether this counting system is then indicating a number of faults equal or not to a number m which can be set by the manufacturer of such a terminal. For example, m may have the value 20. If the counting system then indicates a number of faults equal to the number m, the cell exits from the black list at box 507 and the counting system is then reinitialized by reinitialization means. If the counting system then indicates a number of faults less than the number m, nothing occurs after box 506. Boxes 505 to 507 form an algorithm for exiting from a black list 508.

FIG. 6 illustrates a selection of a cell for camping in idle mode and management of the black list. At box 601, the terminal wishes to camp on a cell in idle mode. The terminal checks whether this cell is the only one present in its list of neighbors. This is because, if the cell is alone in the list of neighbors, the terminal camps on this cell in idle mode, independently of the fact that it is situated or not in the black list, since in such a situation the terminal does not have any other choices of a possible cell for camping in idle mode.

At box 602, the cell is alone in the list of neighbors. The terminal then decides at box 603 to camp on this cell in idle mode. The terminal then wishes to switch to a dedicated mode on this cell. At box 604, such a switching is effected. The counting system associated with this cell is then reinitialized at box 605. At box 606, the switching fails because of a fault in the base station controlling this cell. The terminal then checks at box 607 whether this cell is present in the black list. If it is not present in the black list, the terminal then initiates, at box 608, the algorithm for entry into a black list 405. If it is present in the black list, the terminal then initiates, at box 608, the algorithm for exiting from a black list 508.

At box 610, the cell is not alone in the list of neighbors. The terminal then verifies, at box 611, whether this cell is present in the black list. If it is present in the black list, the terminal decides, at box 612, not to camp on this cell and at box 613 initiates the algorithm for exiting from a black list 508. In addition, if this cell is situated in the list of close neighbor cells, the terminal places it in the list of distant neighbor cells in order to enable a cell in the list of distant neighbor cells to enter the list of close neighbor cells. If the cell is not present in the black list, the terminal decides at box 614 to camp on this cell in idle mode. The terminal then wishes to switch to dedicated mode on this cell. At box 615, the switching fails because of a fault in the base station controlling this cell. The terminal then initiates, at box 616, the algorithm for entry into a black list 405. At box 617, such a switching is effected. The counting system associated with this cell is then reinitialized at box 618.

The above description with reference to the figures illustrates the invention rather than limiting it. In this regard, a few remarks are made below.

The description of the figures is based on the example of a telecommunication network of the GSM type. Naturally, the invention applies to other types of network, possibly more highly developed than the network of the GSM type, provided that these networks comprise terminals able to switch from idle mode to dedicated mode, said terminals exchanging data with a relay in order to effect this switching.

In FIG. 5a, a mode of exiting from a black list is described. It is possible to vary this mode, without departing from the spirit of the invention. For example, the terminal can store the day and month of entry of a cell into the black list and make this cell exit from the black list after a certain period following its entry, for example two months.

In principle, it is possible to implement the method according to the invention by means of a suitably programmed integrated circuit. A set of instructions contained in a programming memory may order the integrated circuit to effect the different steps described above. The set of instructions may be loaded into the programming memory by the reading of a data carrier such as, for example, a disk on which the set of instructions is coded. The reading may be effected by means of a communication network such as for example the Internet. In this case, a service provider will make the set of instructions available to interested parties.

1. A telecommunication network comprising
at least one terminal which can switch from an idle mode to a dedicated mode when a communication is established, and
a plurality of cells on which said terminal can camp in idle mode or dedicated mode, controlled by base stations intended to manage such a switching when a communication is established,
characterized in that said terminal comprises:
detection means able to detect a fault in a base station at the time of said switching;
means of identifying the cell controlled by such a faulty base station;
means of establishing a black list of cells controlled by faulty base stations;
means of selecting a cell for camping of said terminal in idle mode, a selection criterion being the presence or not of this cell in the black list.

2. A terminal able to switch from idle mode to dedicated mode when a communication is established, characterized in that it comprises:
detection means able to detect a fault in a base station at the time of said switching;
means of identifying the cell controlled by such a faulty base station;
means of establishing a black list of cells controlled by faulty base stations;
means of selecting a cell for camping of said terminal in idle mode, a selection criterion being the presence or not of this cell in the black list.

3. A terminal as claimed in claim 2, characterized in that a cell exits from said black list after a certain predetermined period following its entry.

4. A terminal as claimed in claim 2, characterized in that said establishment means comprise at least one counting system per cell able to count a number of faults in the base station controlling this cell, said cell entering said black list after a predetermined nonzero number n of faults.

5. A terminal as claimed in claim 4, characterized in that
a counting system associated with a cell present in the black list counts a fault each time the terminal wishes to camp on this cell in idle mode, and
a cell exits from said black list when the counting system associated with said cell indicates a predetermined number m of faults strictly greater than n.

6. A terminal as claimed in claim 4, characterized in that it comprises means of reinitializing a counting system, such a reinitialization taking place either at the time of a successful switching by the base station controlling the cell associated with said counting system, or when this cell exits from the black list.

7. A data processing method for a terminal able to switch from idle mode to dedicated mode when a communication is established, characterized in that it comprises:
a detection step for detecting a fault in a base station at the time of said switching;
a step of identifying the cell controlled by such a faulty base station;
a step of establishing a black list of cells controlled by faulty base stations;
a step of selecting a cell for camping of said terminal in idle mode, a selection criterion being the presence or not of this cell in the black list.

8. A data processing method as claimed in claim 7, characterized in that a cell exits from said black list after a certain predetermined period following its entry.

9. A data processing method as claimed in claim 7, characterized in that said establishment step is performed by means of at least one counting system per cell able to count a number of faults in the base station controlling this cell, said cell entering said black list after a predetermined non-zero number n of faults.

10. A data processing method as claimed in claim 9, characterized in that:
a counting system associated with a cell present in the black list counts a fault each time the terminal wishes to camp on this cell in idle mode, and
a cell exits from said black list when the counting system associated with said cell indicates a predetermined number m of faults strictly greater than n.

11. A data processing method as claimed in claim 9, characterized in that it comprises a step of reinitializing a counting system, such a reinitialization taking place either at the time of a successful switching by the base station controlling the cell associated with said counting system, or when this cell exits from the black list.

12. A program comprising program code instructions for executing the steps of the method as claimed in claim 7 when said program is executed on a processor.
